(19) United States
(12) Patent Application Publication
(10) Pub. No.: US 2008/0017675 A1
(43) Pub. Date: Jan. 24, 2008

(54) POURING APPARATUS

(76) Inventor: Todd Pressey, Toronto (CA)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 11/779,940

(22) Filed: Jul. 19, 2007

(30) Foreign Application Priority Data
Jul. 19, 2006 (CA) 2552513

(51) Int. Cl. B67D 3/00; B65B 1/04

(52) U.S. Cl. 222/481.5; 141/381

(57) ABSTRACT

Apparatus for use with a bottle is disclosed and comprises a pourer and a shot glass. The pourer defines primary and secondary passages and has an operative position occluding the bottle opening whereat, upon inversion of said bottle, the primary passage provides egress for liquid contents from the bottle interior and the secondary passage provides ingress for air into the bottle interior. The shot glass is adapted, when the pourer is operatively positioned on an upright bottle, to be inverted and positioned in an operative position over said pourer to seal the interior of the bottle from atmosphere. The pourer may define an annular groove and the shot glass may have an enlarged rim which engages said annular groove in snap-fit relation in the operative position of the shot glass to provide for mechanical, releasable engagement of the pourer and shot glass. The shot glass may be plastic.

This application claims benefit of the filing date of and right of priority of Canadian Patent Application Ser. No. 2,552,513, filed Jul. 19, 2006 under USC § 119(a).

### FIELD OF THE INVENTION

This invention relates generally to liquor pourers and shot glasses.

### BACKGROUND OF THE INVENTION

In the food service industry, pourers are widely used for dispensing liquor. Since liquor is packaged in a wide variety of bottles by different manufacturers, each bottle having its own unique dispensing characteristics, the use of pourers is advantageous in that same provide to the service staff a predictable flow of liquor when dispensing same, which tends to avoid spillage. As well, in many facilities, pourers are left on bottles at all times, and serve as a form of limited closure therefor. Through the use of pourers in this way, service can be expedited, since staff need not go through the process of removing bottle closures for use, and replacing closures thereafter. A drawback of this use of pourers is that the closure provided by pourers is not hermetic, and over time, bottles can become contaminated by dust and insect infiltration.

Shot glasses are also widely used in the food service industry for measuring and/or vending liquor. Multiple shot glasses are typically utilized in refined establishments, so as to avoid cross-contamination between liquors. This has an associated cost in terms of dishwashing capacity and labour.

### SUMMARY OF THE INVENTION

Apparatus for use with a bottle is disclosed. The bottle is of the type having an interior and a tubular neck defining an opening leading into said interior. This apparatus comprises a pourer and a shot glass. The pourer defines primary and secondary passages and has an operative position occluding said opening whereat, upon inversion of said bottle, said primary passage provides egress for liquid contents from the interior of the bottle and said secondary passage provides ingress for air into the interior of the bottle. The shot glass is adapted, when said pourer is operatively positioned on said bottle and said bottle is orientated upright, to be inverted and positioned in an operative position over said pourer to seal the interior of the bottle from atmosphere.

This apparatus provides substantial advantage in terms of hygiene and cost and labor savings in the food service industry. The shot glasses provide a substantially hermetic seal for the bottles, so as to reduce the incidence of contamination. In use, the bottle and attached glass can be conveniently grasped by the server, the cap removed with one hand from the bottle, and a shot of liquor dispensed, for use. If the bottle contains a liquor which is likely to be used again shortly, the cap can then be loosely disposed on the top of the bottle for subsequent dispensing. At the end of the evening, or at any other time when it appears that the bottle is likely not to be used again, a clean cap can be snap-fit on top of the bottle, and the soiled cap washed, for subsequent reuse at a later date. This arrangement reduces the need for shot glass washing; helps to avoid cross-contamination; and tends to reduce liquor spoilage.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter being briefly described hereinbelow.

### BRIEF DESCRIPTION OF THE DRAWINGS

FIG. 1 is a bottom, side perspective view of apparatus constructed according to a preferred embodiment of the invention;

FIG. 2 is a cross-section view of the structure of FIG. 1 in use, operatively disposed on a bottle;

FIG. 3 is a partially exploded, side cross-sectional view of the structure of FIG. 1;

FIG. 4 is an enlarged view of encircled area 4 in FIG. 3;

FIG. 5 is an enlarged view of encircled area 5 in FIG. 3;

FIG. 6 is a bottom perspective view of a portion of FIG. 1;

FIG. 7 is a side perspective view of the structure of FIG. 6;

FIG. 8 is a perspective view of a portion of the structure of FIG. 1;

FIG. 9 is a side perspective view of the structure of FIG. 8;

FIG. 10 is a perspective view of the structure of FIG. 8, from a different vantage point;

FIG. 11 is a bottom perspective view of the structure of FIG. 8;

FIG. 12 is a perspective view of a portion of the structure of FIG. 1;

FIG. 13 is a perspective view of the structure of FIG. 12, from a different vantage point;

FIG. 14 is a perspective view of the structure of FIG. 12, from a different vantage point;

FIG. 15 is a perspective view of the structure of FIG. 12, from a different vantage point;

FIG. 16 is a perspective view of a portion of the structure of FIG. 16;

FIG. 17 is a perspective view of the structure of FIG. 16, from a different vantage point;

FIG. 18 is a perspective view of the structure of FIG. 16, from a different vantage point; and

FIG. 19 is a perspective view of the structure of FIG. 16, from a different vantage point.

### DESCRIPTION

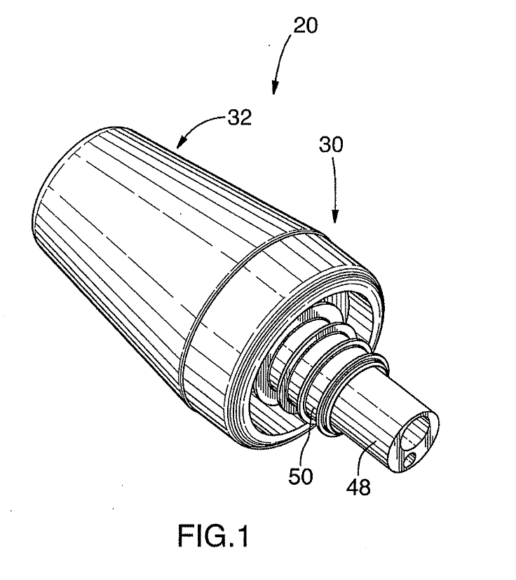

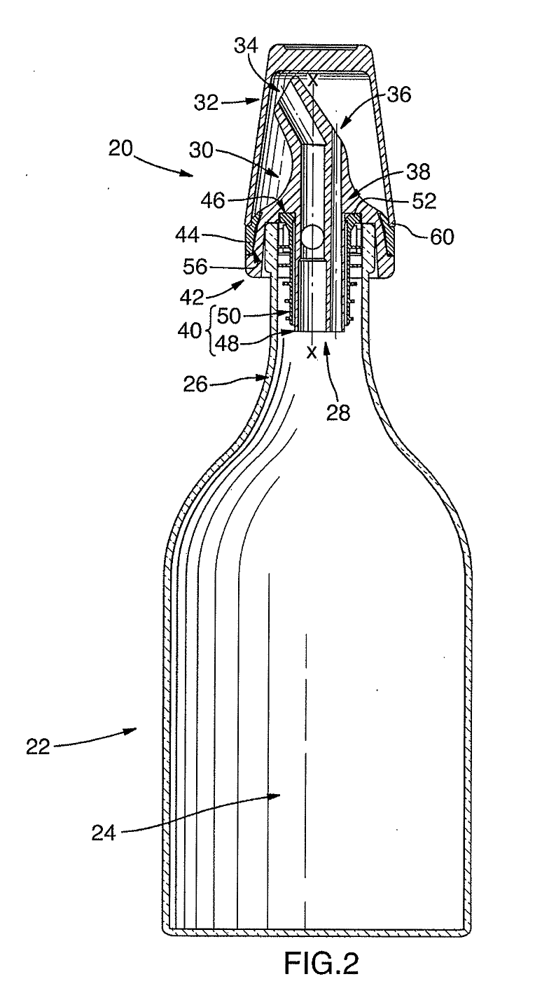

Apparatus constructed according to a preferred embodiment of the present invention is shown in FIG. 1 and designated with general reference numeral 20. In FIG. 2, the apparatus is shown, in cross-section, in use with a conventional upright bottle 22 of the type having an interior 24 and a tubular neck 26 defining an opening 28 leading into said interior. It should be understood that the bottle 22 does not form part of the invention.

Generally, the apparatus 20 comprises a pourer 30 and a standard 1 oz. shot glass 32.

The pourer 30 is shown disposed in an operative position in FIG. 2 atop the bottle 22 and will be seen to define a longitudinal axis X-X and primary 34 and secondary 36 passages and to comprise a cap part 38, a plug part 40, a skirt part 42 and an annular insert 44.

As illustrated in FIG. 2, the cap part 38 is seated atop the neck 26 of the bottle 22 and defines an annular channel 46 presenting downwardly.

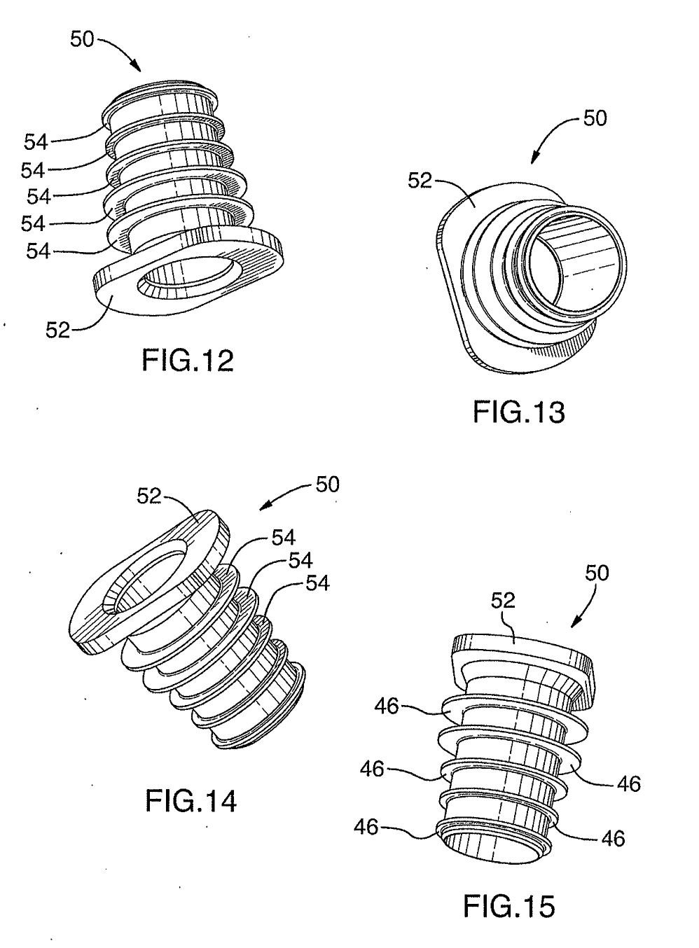

The plug part 40 comprises a plug body 48 and an annular stopper 50. The plug body 48 extends longitudinally from the cap part 38 through the interior of the annular stopper 50 to project into the neck 26 of the bottle 22. The annular stopper 50 is arranged concentrically within the neck 26 to sealingly engage the interior of the neck, and has an enlarged rim 52 fitted within annular channel 46. The annular stopper 50 is shown in isolation in FIG. 12 and will be seen to have a plurality of radial, annular flanges or ribs 54, axially spaced from one another, said flanges decreasing in diameter as the plug part 40 extends from the cap part 38, said flanges 54 providing for said sealing engagement of the stopper 50 and the interior of the neck 26 when the pourer 30 is operatively positioned.

Returning to FIG. 2, the annular skirt part 42 extends from the cap part 38 and around the neck 26 of the bottle, and defines an annular recess 56.

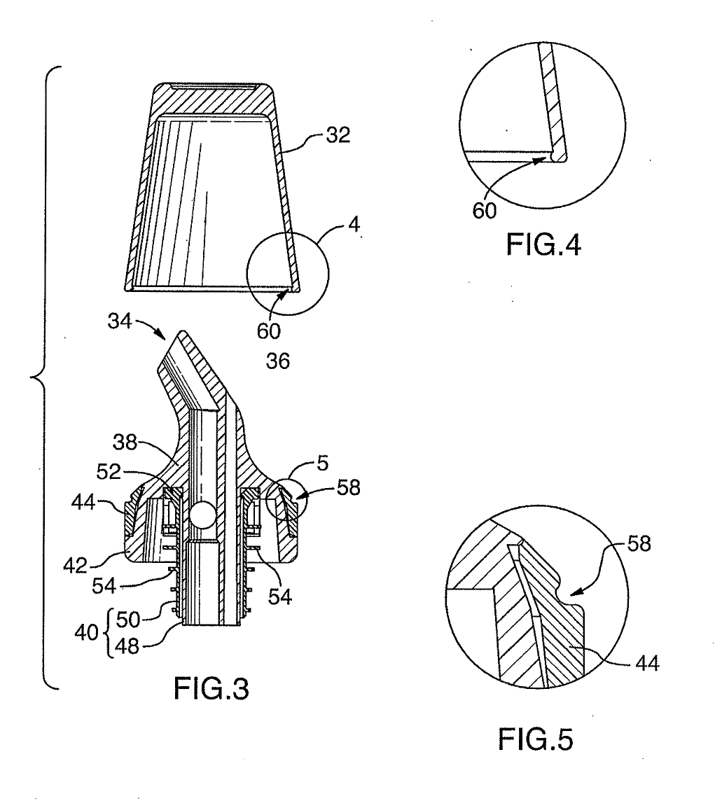

The annular insert 44 is disposed in said annular recess 56 in snap-fit engagement with said skirt part 42, and defines an annular groove 58, best seen in FIG. 3.

The pourer 30 has an operative position occluding said opening as shown in FIG. 2, whereat, upon inversion of said bottle, said primary passage provides egress for liquid contents from the interior of the bottle and said secondary passage provides ingress for air into the interior of the bottle.

The shot glass 32 has an enlarged rim 60, best seen in FIG. 3, and has an operative position as shown in FIG. 2 wherein the enlarged rim 60 engages said annular groove 58 in snap-fit relation to provide for mechanical, releasable engagement of the pourer 30 and shot glass 32 so as to resist separation of the shot glass 32 from the pourer 30. This resistance to separation is advantageous in that it tends to ensure that the bottle contents are sealed, and also tends to reduce the likelihood that the shot glass 32 will be inadvertently knocked from the bottle in typical usage.

In terms of construction, the preferred apparatus 20 is constructed out of four discrete injection-molded parts.

The shot glass 32, shown in isolation in FIGS. 6, 7, forms a first of said parts and is constructed out of a rigid food-grade, preferably transparent plastic material.

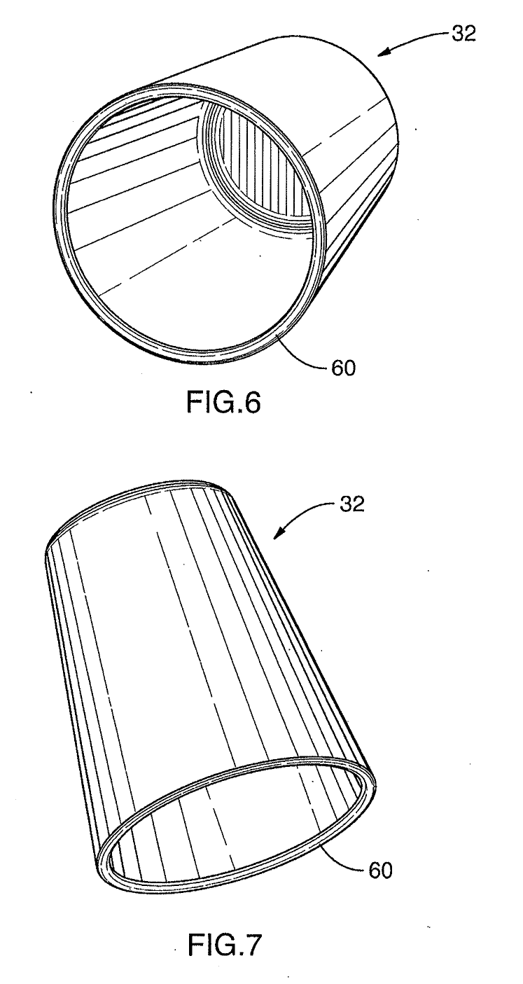

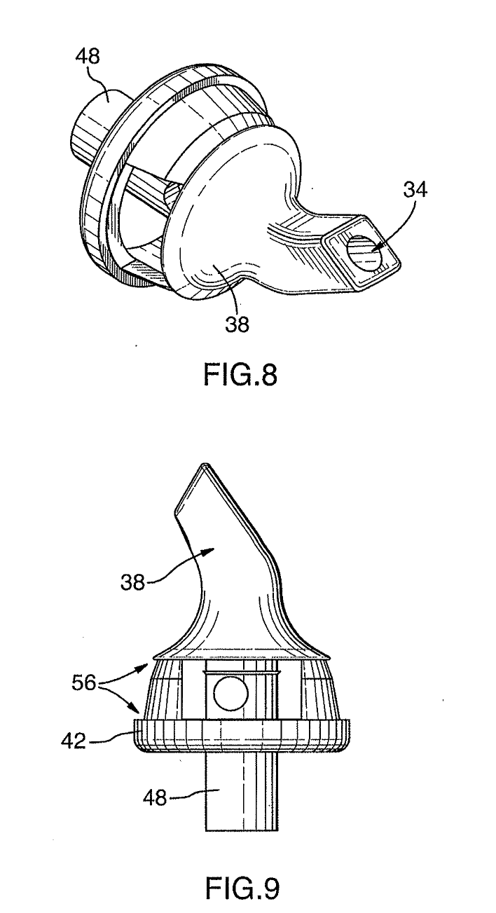

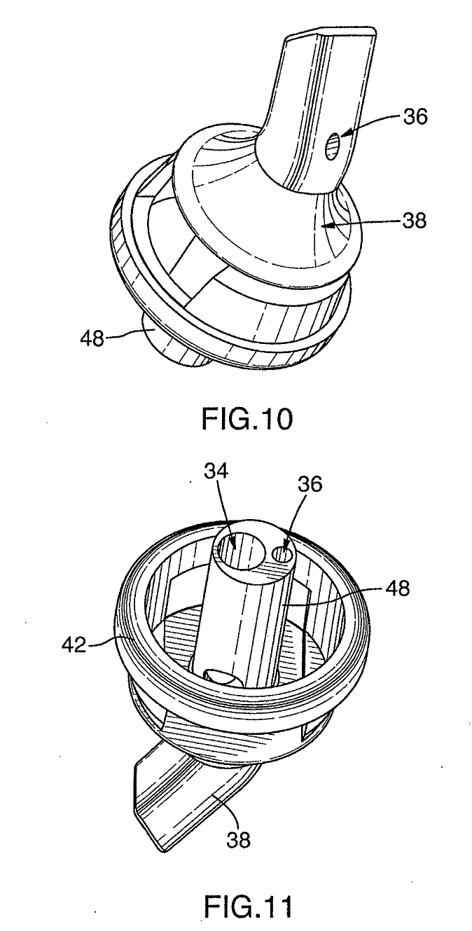

The plug body 48, skirt part 42 and cap part 38 are formed integrally out of a rigid food-grade plastic material as a second of said parts, as shown in each of FIGS. 8-11.

The stopper 50 is formed out of an elastomeric, food-grade plastic material as a third of said parts, as shown in each of FIGS. 12-15. The formation of the stopper 50 as a distinct part is advantageous, in that it permits the use of a plastic material more elastic than the balance of the pourer, and also facilitatse the provisions of the radial flanges, which would otherwise be difficult to mold.

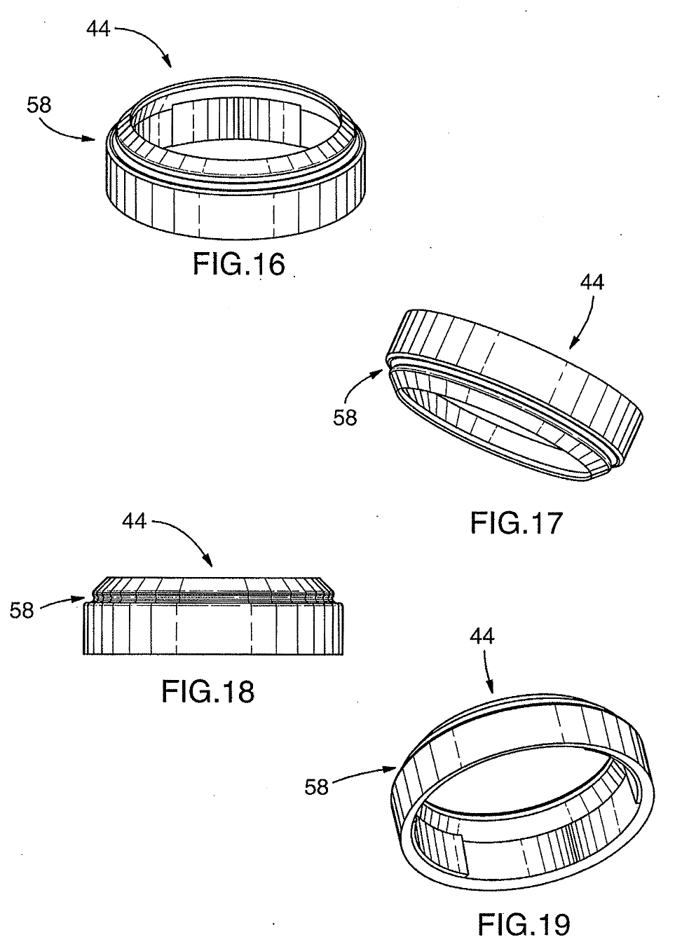

The insert 44, shown in each of FIGS. 16-19, forms the final part, and is also formed out of a suitable food-grade plastic material. The formation of the insert as a part distinct from the skirt body is advantageous, in that it permits the provision of groove 58, which would be difficult to mold in the skirt part.

The plastics chosen will have sufficiently resilience to provide for the snap-fit engagement of the insert onto the skirt part, and of the shot glass onto the pourer. The details of plastics suitable for this purpose are well-known to persons of ordinary skill in the art, and as such, as not described herein in detail.

While but a single embodiment of the present invention has been herein shown and described, it will be understood that various changes in size and shape of parts may be made, without departing from spirit or scope of the invention.

For example, only, whereas a 1 oz shot glass is described, it will be evident that vessels of other sizes, such as 1½ oz, could easily be utilized. Accordingly, the invention should be understood as limited only by the claims appended hereto, purposively construed.

1. Apparatus for use with a bottle having an interior and a tubular neck defining an opening leading into said interior, said apparatus comprising:
a pourer defining primary and secondary passages and having an operative position occluding said opening whereat, upon inversion of said bottle, said primary passage provides egress for liquid contents from the interior of the bottle and said secondary passage provides ingress for air into the interior of the bottle; and
a shot glass adapted, when said pourer is operatively positioned on said bottle and said bottle is orientated upright, to be inverted and positioned in an operative position over said pourer to seal the interior of the bottle from atmosphere.

2. Apparatus according to claim 1, wherein the pourer and shot glass are adapted such that, when said shot glass is operatively positioned, said shot glass and pourer engage one another so as to resist separation of the shot glass from the pourer.

3. Apparatus according to claim 2, wherein the pourer and shot glass mechanically, releasably, engage one another when the shot glass is operatively positioned.

4. Apparatus according to claim 3, wherein the pourer defines an annular groove and the shot glass has an enlarged rim which engages said annular groove in snap-fit relation in the operative position of the shot glass to provide for said mechanical, releasable engagement of the pourer and shot glass.

5. Apparatus according to claim 4, wherein the pourer defines a longitudinal axis and comprises:
a cap part which sits atop the neck of the bottle when the pourer is operatively positioned and the bottle is orientated upright;
a plug part longitudinally extending from the cap part which projects into the neck of the bottle when the pourer is operatively positioned; and
an annular skirt part extending from the cap part and around the neck of the bottle when the pourer is operatively positioned.

6. Apparatus according to claim 5, wherein the plug part comprises:
an annular stopper arranged concentrically within the neck and sealingly engaging the interior of the neck when the pourer is operatively positioned; and
a plug body extending through the interior of the annular stopper.

7. Apparatus according to claim 6, wherein the cap part defines an annular channel extending around the plug body and presenting downwardly when the pourer is operatively positioned and the bottle is orientated upright;

8. Apparatus according to claim 7, wherein the annular stopper has an enlarged rim fitted within the annular channel.

9. Apparatus according to claim 6, wherein the annular stopper has a plurality of radial, annular flanges, axially spaced from one another, said flanges decreasing in diameter as the plug part extends from the cap part, said flanges providing for said sealing engagement of the stopper and the interior of the neck when the pourer is operatively positioned.

10. Apparatus according to claim 5, wherein the skirt part defines an annular recess.

11. Apparatus according to claim 10, further comprising:
an annular insert disposed in said annular recess in snap-fit engagement with said skirt part, said insert defining the annular groove.

12. Apparatus according to claim 1, wherein the shot glass is constructed out of a plastic material.

13. Apparatus according to claim 6, wherein the plug body, skirt part and cap part are formed integrally out of a plastic material.

14. Apparatus according to claim 6, wherein the stopper is formed out of an elastomeric plastic material.
